(19) United States
(12) Patent Application Publication
(10) Pub. No.: US 2024/0345789 A1
(43) Pub. Date: Oct. 17, 2024

(54) DISPLAY SYSTEM, DISPLAY DEVICE AND METHOD

(71) Applicant: Japan Display Inc., Tokyo (JP)

(72) Inventors: Keiji Tago, Tokyo (JP); Muneaki Zako, Tokyo (JP); Tenfu Nakamura, Tokyo (JP); Toshinori Uehara, Tokyo (JP)

(21) Appl. No.: 18/614,832

(22) Filed: Mar. 25, 2024

(30) Foreign Application Priority Data
Apr. 12, 2023 (JP) 2023-064946

(51) Int. Cl. G06F 3/14; G06T 7/70; G09G 3/36

(52) U.S. Cl. CPC G06F 3/14; G06T 7/70; G09G 3/36

(57) ABSTRACT

According to one embodiment, a display system includes a display device and a control device. The display device includes a pair of transparent substrates and a polymer dispersed liquid crystal layer held between the pair of transparent substrates. The control device controls display of images in the display device. The display device is transparent to a background on one side when viewed from another side of the pair of transparent substrates, and is transparent to a background on the other side when viewed from the one side of the pair of transparent substrates. The control device detects a position of a person based on a first image, and displays a second image based on the detected position.

### CROSS-REFERENCE TO RELATED APPLICATIONS

This application is based upon and claims the benefit of priority from Japanese Patent Application No. 2023-064946, filed Apr. 12, 2023, the entire contents of which are incorporated herein by reference.

### FIELD

Embodiments described herein relate generally to a display system, a display device and a method.

### BACKGROUND

In recent years, display devices with polymer-dispersed liquid crystals held between a pair of transparent substrates (transparent displays) have been known.

Such display devices have a high degree of transparency, and therefore new applications thereof utilizing such characteristics are being explored.

### BRIEF DESCRIPTION OF THE DRAWINGS

FIG. 1 is a diagram showing an example of a configuration of a display system according to an embodiment.

FIG. 2 is a plan view showing an example of a display device.

FIG. 3 is a plan view showing an area near a light emitting module.

FIG. 4 is a cross-sectional view showing the display device.

FIG. 5 is a diagram illustrating an overview of the display system.

FIG. 6 is a diagram illustrating an example of a display image when a subject views the display device from an upper direction.

FIG. 7 is a diagram illustrating an example of a display image when a subject views the display device from a lower direction.

FIG. 8 is a block diagram showing a configuration of a control device.

FIG. 9 is a flowchart showing an example of a processing procedure of the display system.

FIG. 10 is a diagram illustrating the case where a plurality of persons are present in the vicinity of the display system.

FIG. 11 is a diagram illustrating an angle at which the subject is positioned in relation to the display device.

FIG. 12 is a diagram illustrating an angle at which the subject is positioned in relation to the display device.

FIG. 13 is a diagram showing another example of a display image.

### DETAILED DESCRIPTION

In general, according to one embodiment, a display system includes a display device and a control device. The display device includes a pair of transparent substrates and a polymer dispersed liquid crystal layer held between the pair of transparent substrates. The control device controls display of images in the display device. The display device is transparent to a background on one side when viewed from another side of the pair of transparent substrates, and is transparent to a background on the other side when viewed from the one side of the pair of transparent substrates. The control device detects a position of a person with respect to the display device based on a first image containing the person obtained by an image capturing device which captures the person, and displays a second image containing an object on the display device based on the detected position.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

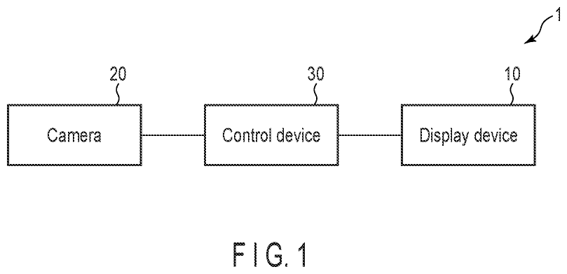

FIG. 1 shows an example of the configuration of a display system according to this embodiment. As shown in FIG. 1, the display system 1 includes a display device 10, a camera (image capturing device) 20, and a control device 30.

The display device 10 is a transparent display including a pair of transparent substrates and a polymer dispersed liquid crystal layer held between the pair of transparent substrates, as will be described later. The display device 10 (transparent display) with such a structure is configured so that when viewed from one side of the pair of transparent substrates, the background on the other side can be seen through and when viewed from the other side of the pair of transparent substrates, the background on the one side can be seen through. Further, the display device 10 is configured to be able to partially switch between a scattering state in which incident light is scattered and a transparent state in which incident light is transmitted in the display area.

The camera 20 is attached to the display device 10, for example, and acquires an image including a person present in the vicinity of the display device 10 by capturing the person.

The control device 30 controls display of images on the display device 10. More specifically, the control device 30 detects the position of the person included in the image based on the image acquired by the camera 20, and displays an image including the object on the display device 10 based on the detected position of the person.

The display device 10 (transparent display) provided in the display system 1 of this embodiment will be described below.

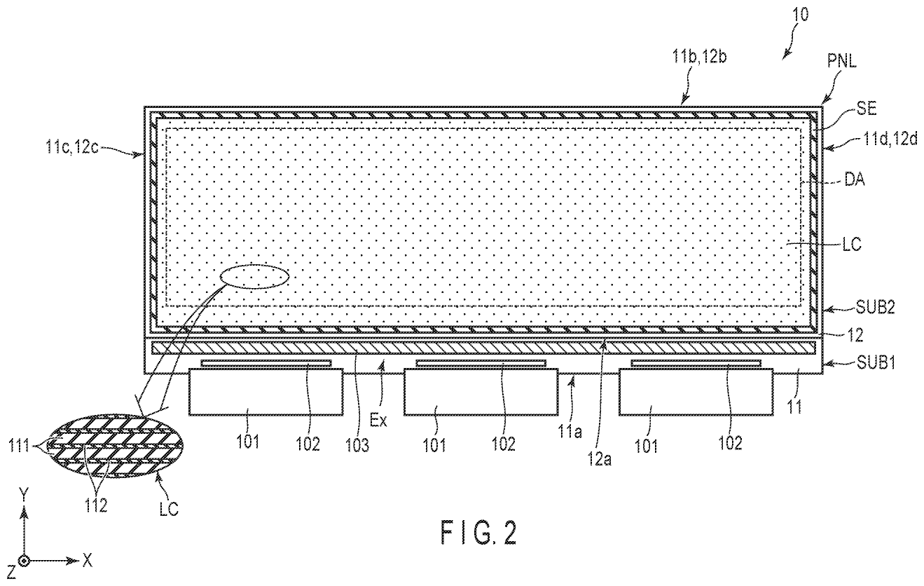

FIG. 2 is a plan view showing an example of the display device 10. For example, a first direction X, a second direction Y, and a third direction Z are orthogonal to each other, but may intersect at an angle other than 90 degrees. The first direction X and the second direction Y correspond to directions parallel to the main surface of the substrate which constitutes the display device 10, and the third direction Z corresponds to the thickness direction of the display device 10. In this embodiment, viewing an X-Y plane defined by the first direction X and the second direction Y is referred to as plan view.

The display device 10 includes a display panel PNL, wiring substrates 101, IC chips 102, and a light emitting module 103.

The display panel PNL includes a first substrate SUB1, a second substrate SUB2, a liquid crystal layer LC, and a seal SE. The first substrate SUB1 and the second substrate SUB2 are formed into flat plates along the X-Y plane. The first substrate SUB1 and the second substrate SUB2 overlap each other in plan view. The region in which the first substrate SUB1 and the second substrate SUB2 overlap each other includes a display area DA in which images are displayed.

The first substrate SUB1 includes a first transparent substrate 11 and the second substrate SUB2 includes a second transparent substrate 12. The first transparent substrate 11 includes side surfaces 11a and 11b along the first direction X and side surfaces 11c and 11d along the second direction Y. The second transparent substrate 12 includes side surfaces 12a and 12b along the first direction X and side surfaces 12c and 12d along the second direction Y.

In the example shown in FIG. 2, in plan view, the side surfaces 11b and 12b overlap each other, the side surfaces 11c and 12c overlap each other, and the side surfaces 11d and 12d overlap each other, but the side surfaces do not necessarily have to overlap each other. The side surface 12a does not overlap the side surface 11a and is located between the side surface 11a and the display area DA. The first substrate SUB1 includes an extending portion Ex between the side surface 11a and the side surface 12a. That is, the extending portion Ex corresponds to the portion of the first substrate SUB1, which extends in the second direction Y from the portion overlapping the second substrate SUB2, and does not overlap the second substrate SUB2.

In the example shown in FIG. 2, the display panel PNL is formed in a rectangular shape extending in the first direction X. That is, the side surfaces 11a and 11b and the side surfaces 12a and 12b are respective side surfaces along the long edges of the display panel PNL. The side surfaces 11c and 11d and the side surfaces 12c and 12d are respective side surfaces along the short edges of the display panel PNL. Note that the display panel PNL may be formed into a rectangular shape extending along the second direction Y, or into a square shape, or in other shapes such as polygonal, circular or oval shapes.

The wiring substrates 101 and the IC chips 102 are mounted on the extending portion Ex. The wiring substrate 101 is, for example, a bendable flexible printed circuit board. The IC chips 102 each incorporate, for example, a display driver or the like, that outputs signals necessary for image display. Note that the IC chips 102 may be mounted on the wiring substrate 101. In the example shown in FIG. 2, a plurality of wiring substrates 101 aligned in the first direction X are mounted on the display panel PNL, but a single wiring substrate 101 extending in the first direction X may as well be mounted in place. Further, a plurality of IC chips 102 aligned in the first direction X are mounted onto the display panel PNL, but a single IC chip 102 extending in the first direction X may as well be mounted in place.

Details of the light emitting module 103 will be described later. The light emitting module 103 is arranged to overlap the extending portion Ex in plan view, and to be along the side surface 12a of the second transparent substrate 12.

The seal SE adheres the first substrate SUB1 and the second substrate SUB2 together. The seal SE is formed into a rectangular frame shape and surrounds the liquid crystal layer LC between the first substrate SUB1 and the second substrate SUB2.

The liquid crystal layer LC is a polymer dispersed liquid crystal layer mentioned above, and is held between the first substrate SUB1 and the second substrate SUB2 (that is, between the pair of transparent substrates 11 and 12). The liquid crystal layer LC with such a configuration is arranged over the region surrounded by the seal SE (including the display area DA) in plan view.

Here, as schematically and enlargedly shown in FIG. 2, the liquid crystal layer LC includes polymers 111 and liquid crystal molecules 112. For example, the polymers 111 are liquid crystalline polymers. The polymers 111 are formed in stripes extending along the first direction X and aligned along the second direction Y. The liquid crystal molecules 112 are dispersed in the gaps between the polymers 111 and are aligned so that their long axes are along the first direction X. Each of the polymers 111 and the liquid crystal molecules 112 has an optical anisotropy or refractive index anisotropy. The responsivity of the polymers 111 to an electric field is lower than the responsivity of the liquid crystal molecules 112 to an electric field.

For example, the alignment direction of the polymers 111 does not substantially change regardless of whether there is an electric field or not. On the other hand, the alignment direction of the liquid crystal molecules 112 changes in response to an electric field when a high voltage higher than or equal to the threshold is applied to the liquid crystal layer LC. When no voltage is being applied to the liquid crystal layer LC (an initial alignment state), the respective optical axes of the polymers 111 and liquid crystal molecules 112 are substantially parallel to each other, and light incident on the liquid crystal layer LC is substantially completely transmitted through the liquid crystal layer LC (a transparent state). When voltage is being applied to the liquid crystal layer LC, the alignment direction of the liquid crystal molecules 112 changes and the respective optical axes of the polymers 111 and liquid crystal molecules 112 cross each other. Therefore, light incident on the liquid crystal layer LC is scattered within the liquid crystal layer LC (a scattered state).

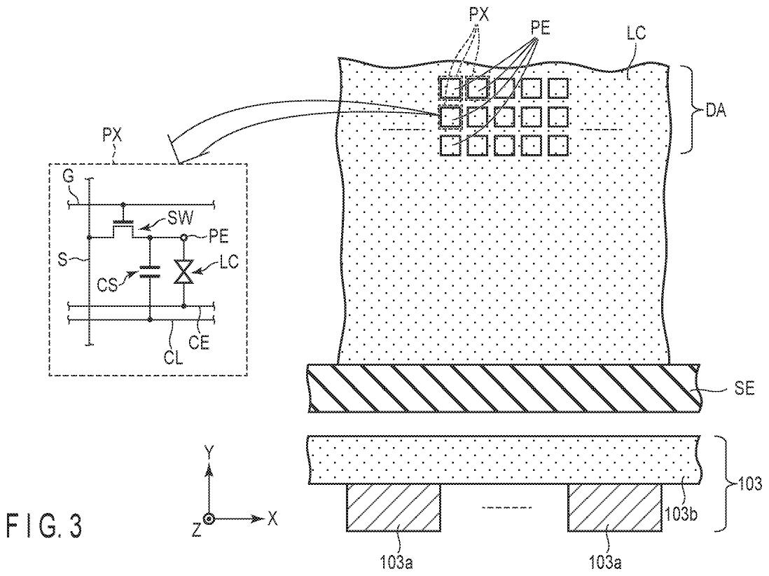

FIG. 3 is a plan view of the area near the light emitting module 103. The light emitting module 103 includes a plurality of light emitting elements 103a and a light guide 103b. The plurality of light emitting elements 103a are aligned along the first direction X. The light guide 103b is formed into a rod shape extending along the first direction X. The light guide 103b is positioned between the seal SE and the light emitting elements 103a.

The display area DA includes a plurality of pixels PX arranged in a matrix along the first direction X and the second direction Y. These pixels PX are depicted by dotted lines in the figure. Further, each of the pixels PX includes a pixel electrode PE depicted by a solid square in the figure.

As enlargedly shown in FIG. 3, each of the pixels PX includes a switching element SW. The switching element SW is constituted by a thin-film transistor (TFT), for example, and is electrically connected to a respective scanning line G and a respective signal line S. The scanning line G is electrically connected to the switching element SW in each of the pixels PX aligned along the first direction X. The signal line S is electrically connected to the switching element SW in each of the pixels PX aligned along the second direction Y. The pixel electrode PE is electrically connected to the switching element SW.

A common electrode CE and a power feed line CL are arranged over the display area DA and its peripheral areas. To the common electrode CE, a predetermined voltage Vcom is applied. A voltage of the same potential as that of the common electrode CE is applied to the power feed line CL, for example.

Each of the pixel electrodes PE opposes the common electrode CE in the third direction Z. In the display area DA, the liquid crystal layer LC (in particular, the liquid crystal molecules 112) is driven by the electric field generated between the pixel electrodes PE and the common electrode CE. The capacitance CS is formed, for example, between the feed line CL and the pixel electrode PE.

Note that the scanning lines G, the signal lines S, the power feed lines CL, the switching elements SW and the pixel electrodes PE are provided on the first substrate SUB1, and the common electrode CE is provided on the second substrate SUB2.

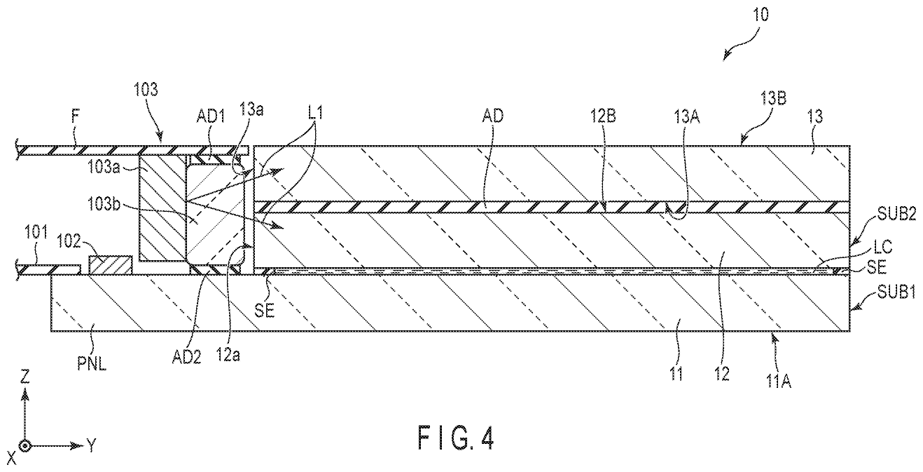

FIG. 4 is a cross-sectional view showing the display device 10. Note that only the main part of the display panel PNL is shown in simplified way.

In addition to the first substrate SUB1 (first transparent substrate 11) and the second substrate SUB2 (second transparent substrate 12), the display panel PNL further includes a third transparent substrate 13. The third transparent substrate 13 includes an inner surface 13A which opposes an outer surface 12B of the second transparent substrate 12 in the third direction Z. The adhesive layer AD adheres the second transparent substrate 12 and the third transparent substrate 13 together. The third transparent substrate 13 is a glass substrate, for example, but may be an insulating substrate such as a plastic substrate. The third transparent substrate 13 has a refractive index equivalent to those of the first transparent substrate 11 and the second transparent substrate 12. The adhesive layer AD has a refractive index equivalent to each of the second transparent substrate 12 and the third transparent substrate 13.

The side surface 13a of the third transparent substrate 13 is located directly above the side surface 12a of the second transparent substrate 12. The light emitting element 103a of the light emitting module 103 is electrically connected to the wiring substrate F and is located between the first substrate SUB1 and the wiring substrate F in the third direction Z. The light guide 103b is provided between the light emitting element 103a and the side surface 12a and between the light emitting element 103a and the side surface 13a in the second direction Y. The light guide 103b is adhered to the wiring substrate F by the adhesive layer AD1 and to the first substrate SUB1 by the adhesive layer AD2.

Here, the light L1 emitted from the light emitting element 103a will now be described with reference to FIG. 4.

The light emitting element 103a emits light L1 toward the light guide 103b. The light L1 emitted from the light emitting element 103a propagates along the direction of the arrow indicating the second direction Y, passes through the light guide 103b, and enters the second transparent substrate 12 from the side surface 12a and also the third transparent substrate 13 from the side surface 13a. The light L1 incident on the second transparent substrate 12 and the third transparent substrate 13 propagates inside the display panel PNL while being repeatedly reflected. The light L1 incident on the liquid crystal layer LC to which no voltage is being applied passes through the liquid crystal layer LC without substantially being scattered. Further, the light L1 incident on the liquid crystal layer LC to which voltage is being applied is scattered by the liquid crystal layer LC.

Note that in the display device 10 described above, each of the plurality of pixels PX arranged in a matrix in the display area DA includes a pixel electrode PE, and the liquid crystal layer LC is driven by the electric field generated between the pixel electrode PE and the common electrode CE. According to the display device 10 with such a configuration, the liquid crystal layer LC can be partially driven by controlling the switching element SW electrically connected to each respective one of the plurality of pixel electrodes PE. In other words, in the display device 10, by partially switching the scattering state and the transparent state of the liquid crystal layer LC described above in the display area DA, it is possible, for example, to display an image on a part of the display area DA and to make other areas of the display area DA into the transparent state(,which is a state where the back of the display device 10 is visible).

Further, the image displayed on the display device 10 (the display area DA) described above can be observed from an outer surface 11A side of the first transparent substrate 11 (hereinafter referred to as “front side”) and further from an outer surface 13B side of the third transparent substrate 13 (hereinafter referred to as “rear side”) as well.

The display system 1 of this embodiment will now be described. The display system 1 of this embodiment has a configuration to provide a new usage of the display device 10 (transparent display) described above.

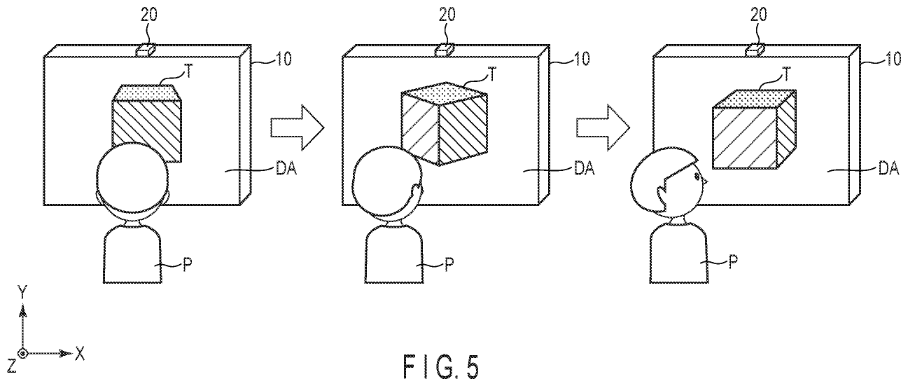

First, an outline of the display system 1 according to this embodiment will be described with reference to FIG. 5. In this embodiment, when displaying an image of a three-dimensional object (in a two-dimensional image) on the display device 10 (transparent display), the image is changed according to the position of a person (hereinafter referred to as the subject person) in the vicinity of the display device 10, and thus pseudo three-dimensional (3D) display of the object can be achieved on the display device 10.

Note that in FIG. 5, the case of displaying an image including an object T having a three-dimensional shape is assumed. In order to make it easy to grasp the changes in the image according to the position of the subject P, the same hatching is applied to the same surface of the object T (cube) in each image in FIG. 5. This is also the case for the following drawings.

As shown in FIG. 5, when the subject P is positioned in front of the display unit 10, the image including the object T viewed from the front is displayed.

On the other hand, when, for example, the subject P moves to a position slightly shifted off to the left from the front with respect to the display device 10 (that is, the subject P views the display device 10 from an oblique direction), an image including the object T viewed from that position (that is, an image as if the object T were viewed from an angle) is displayed.

Further, when, for example, the subject P moves to a position slightly further to the left of the display unit 10 (that is, the subject P views the display unit 10 from the side), an image including the object T viewed from that position (that is, an image as if the object T were viewed from the side) is displayed.

Note that when the object T is displayed in a part of the area of the display device 10 (the display area DA), which is a transparent display, the rear side of the display device 10 is visible in the area other than the area where the object T is displayed, and therefore the subject P changes its direction (angle) according to the position of the subject P and further the subject P can be observed as if it were floating. That is, in this embodiment, the display device 10 can be used to realize visual effects such as augmented reality (AR) and the like.

Further, in this embodiment, it is assumed that an image including an object T whose direction (angle) changes based on the position of the subject P is displayed in a part of the display area DA, but the position of the subject P can be detected (recognized) using the camera 20.

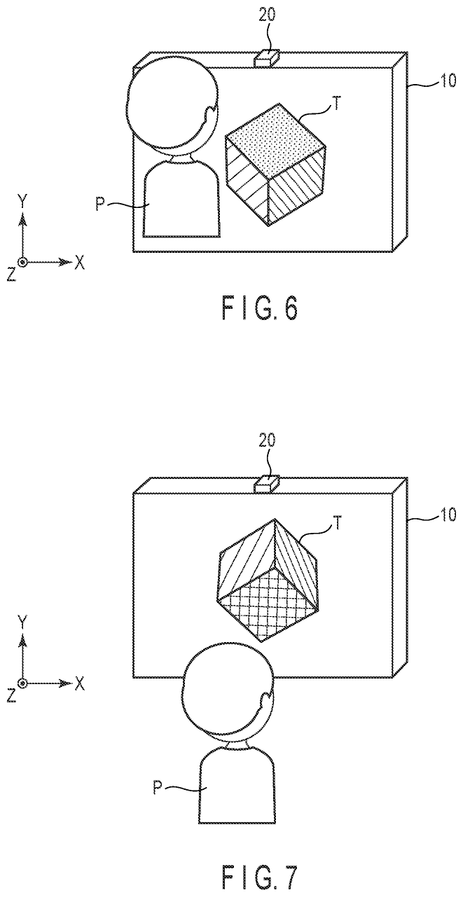

Moreover, in FIG. 5, such a case is assumed that the subject P views the display device 10 from positions (angles) different from the horizontal direction (the first direction X). For example, as shown in FIG. 6, when the subject P views the display device 10 (the display area DA) from an upper direction, an image as if the object T is viewed from the upper direction is displayed. Further, for example, as shown in FIG. 6, when the subject P views the display device 10 (display area DA) from a lower direction, an image such as if the object T were viewed from the lower direction is displayed.

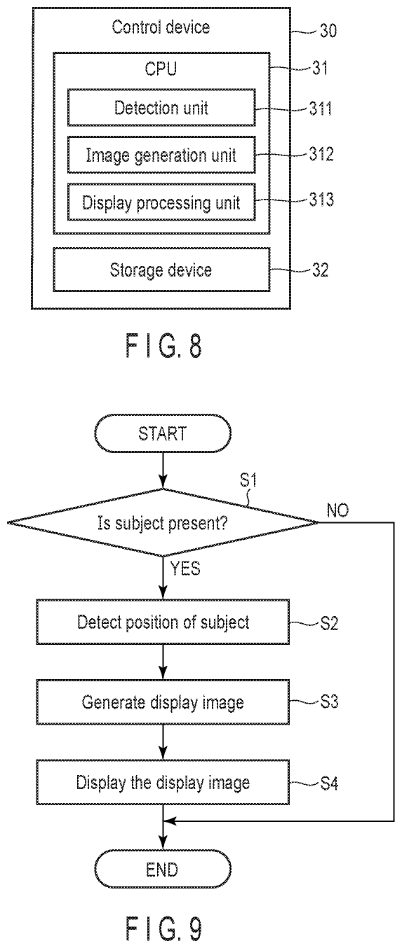

FIG. 8 is a block diagram showing the configuration of the control device 30. As shown in FIG. 8, the control device 30 includes a central processing unit (CPU) 31 and a storage device 32.

The CPU 31 is a processor for controlling the operation of the control device 30, and executes various programs that are loaded into the main memory (not shown) from storage device 32, for example. In FIG. 8, the control device 30 is shown to include the CPU 31, but the CPU 31 may as well be, for example, a graphical processing unit (GPU) or some other processor.

The storage device 32 includes, for example, a solid state drive (SSD) and a hard disk drive (HDD). Note that it is assumed here that the storage device 32 stores a program to be executed by the CPU 31 described above and three-dimensional image data of the object T described above.

Although omitted from FIG. 8, note that the control device 30 is connected communicatively to the display device 10 and the camera 20, and further includes a communication device that executes communications with the display device 10 and the camera 20.

Here, the CPU 31 executes a predetermined program to realize a detection unit 311, an image generation unit 312, and a display processing unit 313.

The detection unit 311 detects the position of the subject P based on an image containing the subject P captured by the camera 20.

The image generating unit 312 generates an image containing the object T based on the position of the subject P detected by the detection unit 311. The image containing the object T is generated based on the three-dimensional image data of the object T stored in the storage device 32 described above. Note here that the three-dimensional image data of the object T is image data that represents the object T by each of a plurality of pixels defined in a three-dimensional coordinate system. According to such three-dimensional image data of the object T, it is possible to generate an image in which the object T is viewed from multiple viewpoints.

The display processing unit 313 executes the process of displaying the image generated by the image generating unit 312 on the display device 10.

With reference to the flowchart in FIG. 9, an example of the processing procedure of the display system 1 in this embodiment will be described.

First, the camera 20 continuously operates to capture images of the space in front of the display device 10, for example. The image acquired by the camera 20 by capturing the space in front of the display device 10 (hereinafter referred to as “captured image”) is transmitted from the camera 20 to the control device 30.

Note that in this embodiment, it is assumed that the camera 20 is attached to the display device 10 as shown in FIG. 5 described above, but the camera 20 may as well be installed in the vicinity of the display device 10 as long as it is capable of capturing images of the space in front of the display device 10.

The detection unit 311 executes image processing on the captured image transmitted from the camera 20, for example and thereby, determines whether or not the subject P is contained in the captured image (that is, the subject P is present in front of the display device 10) (step S1).

When it is determined that the subject P is present (YES in step S1), the detection unit 311 detects the position of the subject P relative to the display device 10 based on the position of the subject P on the image, for example (step S2). The position of the subject P relative to the display device 10 includes, for example, the angle at which the subject P is positioned relative to the display device 10. More specifically, the angle at which the subject P is positioned with respect to the display device 10 is intended to be, for example, the angle made between the direction in which the subject P's face is facing (that is, the subject P's line of sight) and the direction perpendicular to the display surface of the display device 10 (the third direction Z).

When the process of step S2 is executed, the image generating unit 312 acquires the three-dimensional image data of the object T stored in the storage device 32 from the storage device 32.

The image generating unit 312 generates an image containing the object T (hereinafter referred to as a display image) based on the position of the subject P detected in step S3 with respect to the display device 10 and the three-dimensional three dimensional image data of the object T acquired from the storage device 32 (step S3). Note that the display image generated in step S3 is, for example, an image (two-dimensional image) containing the object T in an direction corresponding to the angle at which the subject P is positioned with respect to the display device 10, and more specifically, it is an image representing the state in which the object T is observed (viewed) from the position (angle) of the subject P with respect to the display device 10.

After the process of step S3 is executed, the display processing unit 313 executes the process of displaying the display image generated in the step S3 on the display device 10 (step S4). More specifically, the display processing unit 313 transmits the display image to the display device 10 and instructs the display device 10 (for example, the display driver) to display the display image.

When it is determined in step S1 that the subject P is not present (NO in step S1), the process shown in FIG. 9 is terminated.

In this embodiment, the process shown in FIG. 9 is repeatedly executed while the camera 20 is continuously operating (that is, each time a captured image is transmitted from the camera 20 to the control device 30). With this operation, it is possible to change the direction of the object T displayed on the display unit 10 according to the position of the subject P (that is, a pseudo-three-dimensional display of the object T).

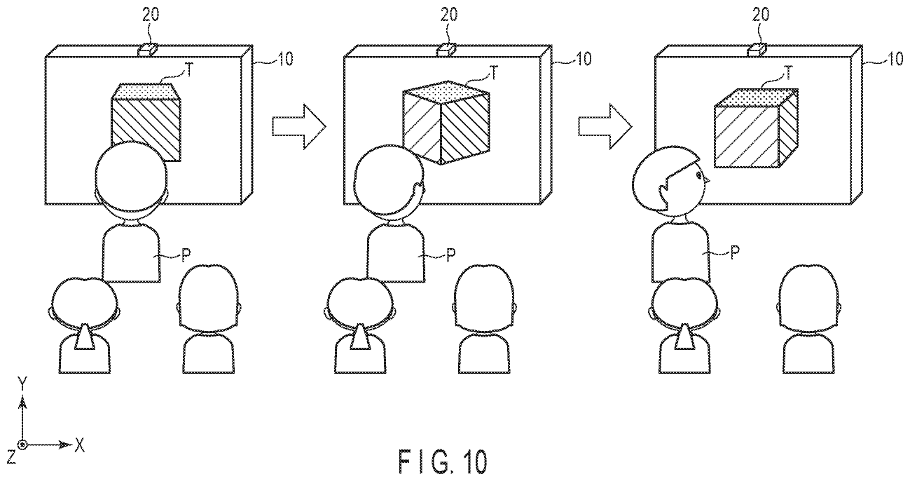

Here, in connection with the above-provided step S2, it is described as that the step is for detecting the position of the subject P. But, when the display device 10 is a large display such as signage, for example, as shown in FIG. 10, a situation can be assumed in which there are multiple persons in front of the display device 10. In such a case, the person closest in distance from the display unit 10 among the multiple persons contained in the captured image is designated as the target person P.

In this case, the distance from the display device 10 may as well be recognized based on, for example, the size of the area occupied by each of the multiple persons in the captured image acquired in step S1, or it may as well be acquired using a distance sensor attached to the display device 10 (such as a sensor that measures the distance to the target using light reflection).

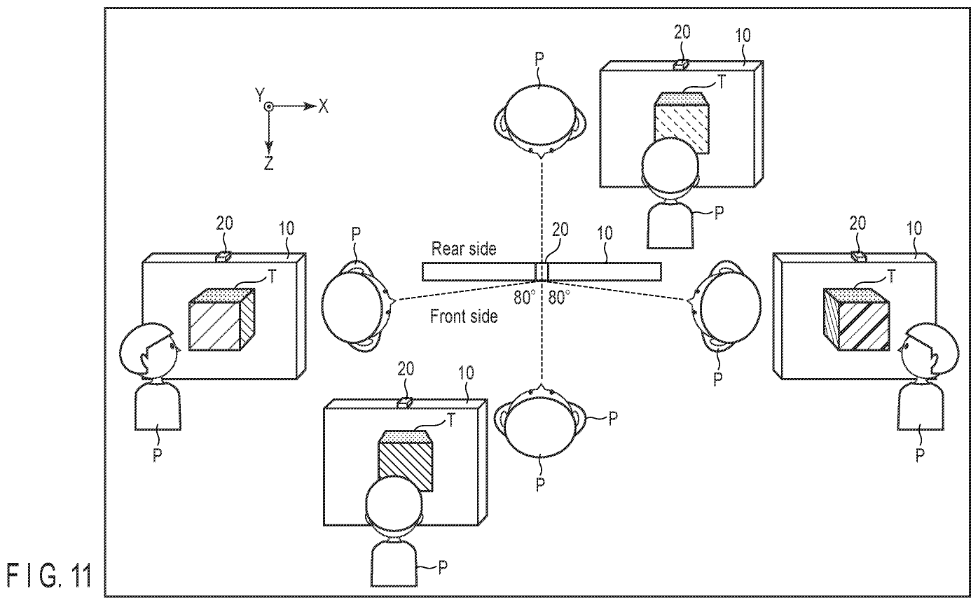

Incidentally, in the above-provided step S2, the angle at which the subject P is positioned in relation to the display device 10 is detected. Here, as shown in FIG. 11, it is assumed that the angle is detected within a range of about ±80 degrees, based on a direction perpendicular to the display surface of the display device 10, for example.

Note that the display device 10 in this embodiment is a transparent display, and the images can be observed from both the front and rear sides of the display device 10. Therefore, as shown in FIG. 11, by arranging the camera 20 so as to capture images not only of the space in front (front side) of the display device 10 but also of the space behind (rear side) of the display device 10, not only the subject P (who is present on the front side of the display device 10) (the position thereof) but also the subject P (who is present on the rear side of the display device 10) (the position thereof) can be detected. According to such a configuration, it is possible, for example, to generate (display) a display image containing the first side (front side) of the object T when the subject P is present on the front side of the display device 10, and also to generate (display) a display image containing the second side (rear side) of the object T, on an opposite side to the first side when the subject P is present on the rear side of the display device 10.

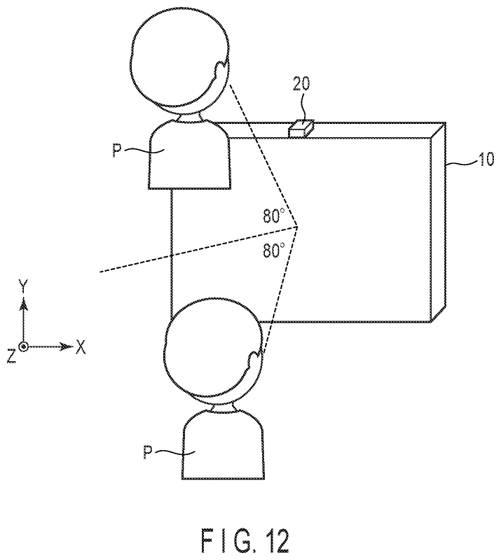

In FIG. 11, the angle in the horizontal direction (the first direction X) is shown, but the angle at which the subject P is positioned with respect to the display device 10 described above includes the angle in the vertical direction (the second direction Y). Note that as shown in FIG. 12, the angle in the vertical direction, as in the case of the angle of the horizontal direction described above, is assumed to be detected within a range of about ±80 degrees based on a direction perpendicular to the display surface of the display device 10, for example.

Further, this embodiment is explained in connection with the case where, for example, an image expressing the state in which the object T is viewed from the position of the subject P with respect to the display device 10 is generated as a display image. But, when the object T is, for example, an organ or the like, it is considered that the display system 1 according to this embodiment can be utilized as a medical education system or learning system that enables observation of the organ from various angles (viewpoints).

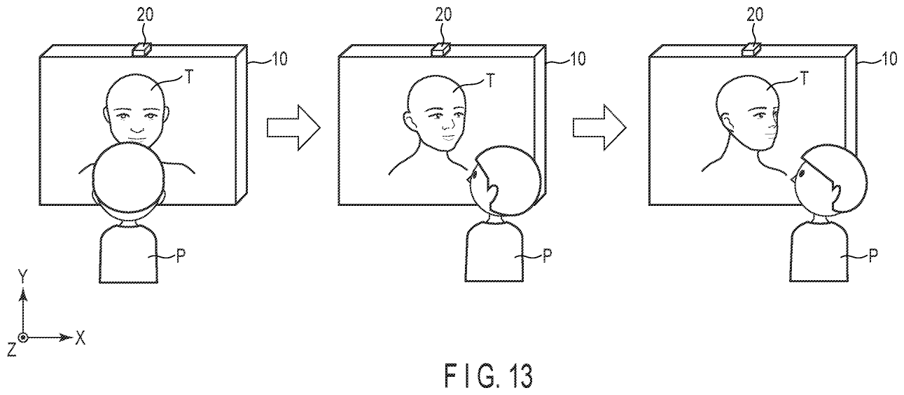

On the other hand, in this embodiment, as shown in FIG. 13, for example, an image expressing a state in which the object T faces the direction of the position of the subject P with respect to the display device 10 (that is, an image in which the direction of the object T changes so that it follows the subject P) may be generated as a display image. Note that in FIG. 13, the example in which the object T is a person (human face) is shown. In such a case, it is considered that the display system 1 of this embodiment may be utilized as a guidance system installed in various facilities equipped with, for example, artificial intelligence (AI), such as airports, stations, and amusement parks.

Further, this embodiment is described in connection with the case where, for example, a display image is generated based on, for example, the position of the subject P with respect to the display device 10. But, the display image may as well be generated based on, for example, the distance from the display device 10 to the subject P. In other words, the display image may be an image that changes according to the angle from which the subject P (the observer) is viewing the display device 10 and also according to the distance from the display device 10 to the subject P. Furthermore, the display image may as well be generated using other information obtained from the captured image.

As described above, the display system 1 of this embodiment includes a display device 10 including a pair of transparent substrates 11 and 12 and a liquid crystal layer LC (polymer dispersed liquid crystal layer) held between the pair of transparent substrates 11 and 12, and a control device 30 that controls the display of images in the display device 10. In this embodiment, the control device 30 detects the position of the subject P relative to the display device 10 based on the captured image (first image) containing the subject P, which is acquired by the camera 20 (image capturing device) capturing the subject P (person), and displays the display image containing the object T (second image) containing the object T based on the detected position.

Note that the position of the subject P relative to the display device 10 includes the angle at which the subject P is positioned relative to the display device 10, and the display image containing the object T in a direction corresponding to the angle is displayed. Further, the display image is generated based on the angle at which the subject P is positioned with respect to the display device 10 and the three-dimensional image data of the object T stored in the storage device 32.

According to this embodiment with such a configuration, it is possible to realize a pseudo-three-dimensional display of the object T by changing the displayed image according to the position of the subject P with respect to the display device 10 (that is, the angle at which the subject P is viewing the display device 10), which enables the display device 10 to be utilized for new applications.

More specifically, for example, in the case of the display system 1 which displays a display image on the display device 10 that expresses the state in which an object T such as an organ is viewed from the position of the subject P relative to the display device 10 detected based on the captured image, the display system 1 (display device 10) can be utilized for applications such as education or learning.

Further, for example, in the case of the display system 1 which displays on the display device 10 a display image expressing a state in which an object T such as a person (human face) is facing the direction of the position of the subject P relative to the display device 10 detected based on the captured image, the display system 1 (display device 10) can be used for guidance in a facility or the like.

Moreover, in this embodiment, the camera 20 may be configured to acquire a captured image containing a subject P by capturing the subject P who is present in front of and behind the display device 10. In such a configuration, when the captured image contains the subject P present in front of the display device 10, a display image containing the front side (first side) of the subject T is displayed on the display device 10, and when the captured image includes the subject P present behind the display device 10, a display image containing the rear side (the second side opposite to the first side) can be displayed on the display device 10. According to such a configuration, it can be expected to further expand the uses of the display device 10.

Further, in this embodiment, when multiple persons are included in the captured image, the person whose distance from the display device 10 is the closest among the multiple persons is designated as the target person P, and the position of the target person P relative to the display device 10 is detected. According to this configuration, even when there are multiple persons in the vicinity of the display device 10, the appropriate person can be selected as the target person P and a display image that changes according to the position of the target person P relative to the display device 10 can be displayed on the display device 10.

Note that it is explained here that the person at the closest distance from the display device 10 is designated as the target person P. But, since it is preferable in this embodiment to select the person who is viewing the display device 10 as the target person P, the person whose face is directed to the display device 10 among the multiple persons in the captured image may be identified as the target person P. Here, whether or not the face is directed to the display device 10 can be recognized, for example, by extracting the area of the face of the person by executing a predetermined image processing on the captured image.

Further, the embodiment may as well be configured such that when a pre-registered person is recognized by executing the face recognition process based on the captured image, for example, the person is designated as the target person P.

In this embodiment, it is assumed that the display device 10 is a transparent display, but there are other transparent displays that include a polymer-dispersion liquid crystal layer as described in this embodiment, for example, those including an organic light emitting diode (OLED). However, the transparent display in this embodiment includes one switching element for one pixel as in the case of general liquid crystal displays, whereas in a display device with an ordinary OLED, there are provided a plurality of switching elements for one pixel and a plurality of signal lines connected respectively to the plurality of switching elements. With this configuration, in the case of transparent displays with OLEDs, the transparency is made lower than that of transparent displays with polymer dispersed liquid crystal layers. With a transparent display with such low transparency, it is difficult to make the subject P feel the reality of the object T, even if the object T is displayed in a pseudo-three-dimensional manner.

Therefore, the display device 10 including a polymer dispersed liquid crystal layer with higher transparency is adopted in this embodiment, and thus it is possible to make the subject P feel the reality of the object T (that is, the subject P feels the object T as more real), thereby improving the entertainment value of using the display device 10.

Further, for example, by operating a touch panel, an object can be rotated and thereby observed from various viewpoints. But since this embodiment is configured to change the displayed image by shifting the position of the subject P (his/her face), the subject P can more intuitively use the display device 10 (display system 1) compared to using a touch panel.

Note that this embodiment is described in connection with the display system 1 including a display device 10, a camera 20, and a control device 30, but the camera 20, for example, may as well be provided outside of the display system 1. Further, at least two of the display unit 10, the camera 20, and the control device 30 may be configured as a single unit. More specifically, the control device 30 may be incorporated into the display unit 10, or the camera 20 and the control device 30 may be incorporated into the display unit 10.

All display systems, display devices and methods, which are implementable with arbitrary changes in design by a person of ordinary skill in the art based on the display systems, display devices and methods described above as the embodiments of the present invention, belong to the scope of the present invention as long as they encompass the spirit of the present invention.

Various modifications are easily conceivable within the category of the idea of the present invention by a person of ordinary skill in the art, and these modifications are also considered to belong to the scope of the present invention. For example, additions, deletions or changes in design of the constituent elements or additions, omissions or changes in condition of the processes may be arbitrarily made to the above embodiments by a person of ordinary skill in the art, and these modifications also fall within the scope of the present invention as long as they encompass the spirit of the present invention.

In addition, the other advantages of the aspects described in the above embodiments, which are obvious from the descriptions of the specification or which are arbitrarily conceivable by a person of ordinary skill in the art, are considered to be achievable by the present invention as a matter of course.

What is claimed is:

1. A display system comprising:
a display device including a pair of transparent substrates and a polymer dispersed liquid crystal layer held between the pair of transparent substrates; and
a control device which controls display of images in the display device, wherein
the display device is transparent to a background on one side when viewed from another side of the pair of transparent substrates, and is transparent to a background on the other side when viewed from the one side of the pair of transparent substrates, and
the control device detects a position of a person with respect to the display device based on a first image containing the person obtained by an image capturing device which captures the person, and displays a second image containing an object on the display device based on the detected position.

2. The display system of claim 1, wherein
the position of the person with respect to the display device includes an angle at which the person is positioned with respect to the display device, and
the control device displays on the display device a second image containing an object directed in accordance with the angle at which the person is positioned with respect to the display device.

3. The display system of claim 2, wherein
the control device includes a storage device that stores three-dimensional image data of the object, and
the second image is generated based on the angle at which the person is positioned with respect to the display device and the three-dimensional image data stored in the storage device.

4. The display system of claim 3, wherein
the control device displays on the display device a second image expressing a state in which the object is viewed from the detected position.

5. The display system of claim 3, wherein
the control device displays on the display device a second image expressing a state in which the object is facing a direction of the detected position.

6. The display system of claim 1, wherein
the image capturing device acquires a first image containing the person by capturing the person in front of or behind the display device, and
the control device displays a second image containing a first side of the object when the first image contains the person present in front of the display device, and displays a second image containing a second side of the object when the first image contains the person present behind the display device, the second side being a side opposite to the first side.

7. The display system of claim 1, wherein
when the first image contains a plurality of persons, the control device detects a position of one of the plurality of persons with respect to the display device, whose distance from the display device is a closest among the plurality of persons.

8. A display device comprising:
a pair of transparent substrates and a polymer dispersed liquid crystal layer held between the pair of transparent substrates; and
a control unit which controls display of images in the display device, wherein
the display device is transparent to a background on one side when viewed from another side of the pair of transparent substrates, and is transparent to a background on the other side when viewed from the one side of the pair of transparent substrates, and
the control unit detects a position of a person with respect to the display device based on a first image containing the person obtained by an image capturing device which captures the person, and displays a second image containing an object on the display device based on the detected position.

9. A method to be executed by a display system comprising a display device including a pair of transparent substrates and a polymer dispersed liquid crystal layer held between the pair of transparent substrates, the display device being transparent to a background on one side when viewed from another side of the pair of transparent substrates, and being transparent to a background on the other side when viewed from the one side of the pair of transparent substrates, and a control device which controls display of images in the display device, the method comprising:
detecting a position of the person with respect to the display device based on a first image containing the person, which is acquired by an image capturing device which captures the person; and
displaying a second image containing the object on the display device based on the detected position.
